(19) United States
(12) Patent Application Publication
(10) Pub. No.: US 2025/0196672 A1
(43) Pub. Date: Jun. 19, 2025

(54) METHODS AND SYSTEM FOR DELIVERING ELECTRIC POWER

(71) Applicant: Ford Global Technologies, LLC, Dearborn, MI (US)

(72) Inventors: Stuart Salter, White Lake, MI (US); Christopher Ballard, Dearborn, MI (US); Brendan Diamond, Grosse Pointe, MI (US); David Celinske, Wolverine Lake, MI (US); Ryan O'Gorman, Beverly Hills, MI (US); Vyas Darshan Shenoy, Canton, MI (US)

(21) Appl. No.: 18/544,933

(22) Filed: Dec. 19, 2023

(51) Int. Cl. B60L 53/18; B60L 53/60; B60L 55/00; H02J 3/32; H02J 7/00; H02J 7/02

(52) U.S. Cl. CPC B60L 53/18; B60L 53/60; B60L 55/00; H02J 3/322; H02J 7/0063; H02J 7/0068; H02J 7/02

(57) ABSTRACT

Methods and systems are provided for combining output of two or more power sources of an electric vehicle to supply electric power to an electric power consumer that is external of a vehicle. In one example, output of the two or more power sources is combined via an aggregation cable.

### FIELD

The present description relates generally to methods and systems for supplying electric power from a vehicle to one or more electric power consumers. The methods and systems may include an aggregation cable for delivering the electric power.

### BACKGROUND/SUMMARY

An electric vehicle may receive and store electric charge via a vehicle charging port. The vehicle charging port may interface with a vehicle charger that is electrically coupled to an electric energy storage device (e.g., a traction battery). The vehicle charging port may accept alternating current (AC) and direct current (DC). The vehicle charger may convert alternating current (AC) to direct current to charge the electric energy storage device. Additionally, the vehicle charging port and the vehicle charger may be bi-directional. In particular, the vehicle charging port may receive electric energy to charge an electric energy storage device that is onboard the vehicle and the vehicle charging port may transfer electric power from the vehicle to the stationary electric power grid when it may be beneficial to do so. However, the vehicle charging port and the vehicle charger may have limited output capacity, and the vehicle's user may wish to provide more than the rated output of the charging port and charger to a charge consumer that is external to the vehicle.

It may be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a schematic diagram of an example vehicle driveline;

FIG. 2 is a schematic of an example aggregation cable for supplying power external to a vehicle;

FIG. 3 shows an example sequence where power cable attributes are communicated to a vehicle so that the vehicle may identify transmission cable configuration and capabilities;

FIGS. 4 and 5 show a flowchart of an example method for determining how a transmission cable may be applied to deliver requested electric power;

FIG. 6 shows an example electric energy transmission cable configuration; and

FIG. 7 shows a flowchart for adjusting outputs of electric power sources.

### DETAILED DESCRIPTION

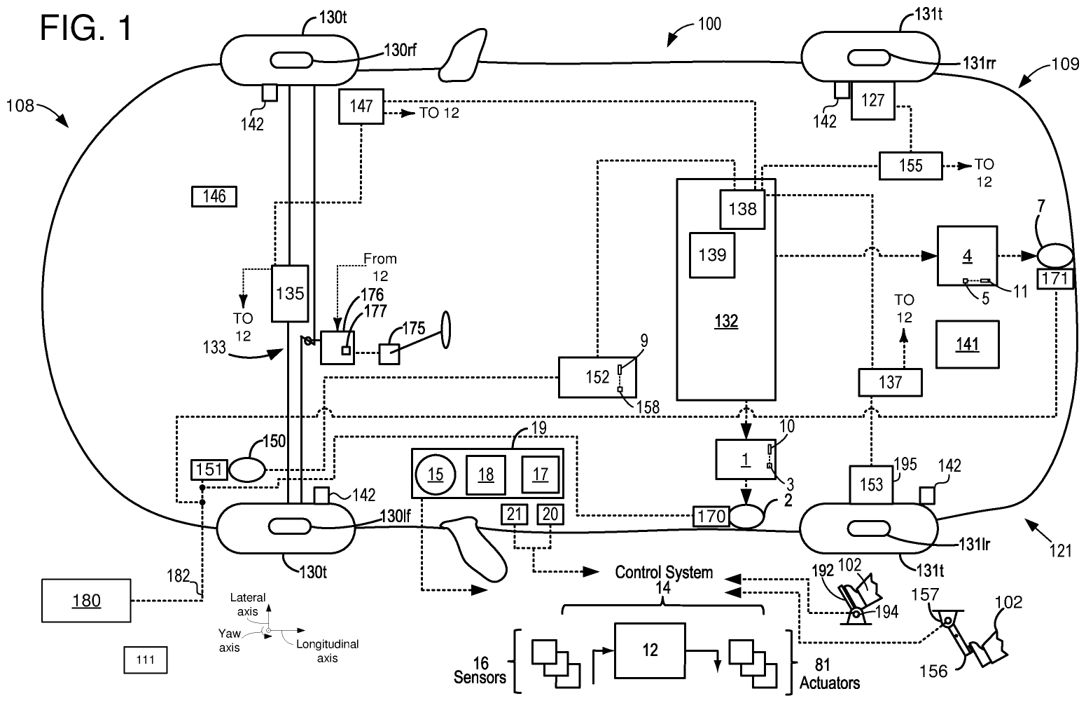

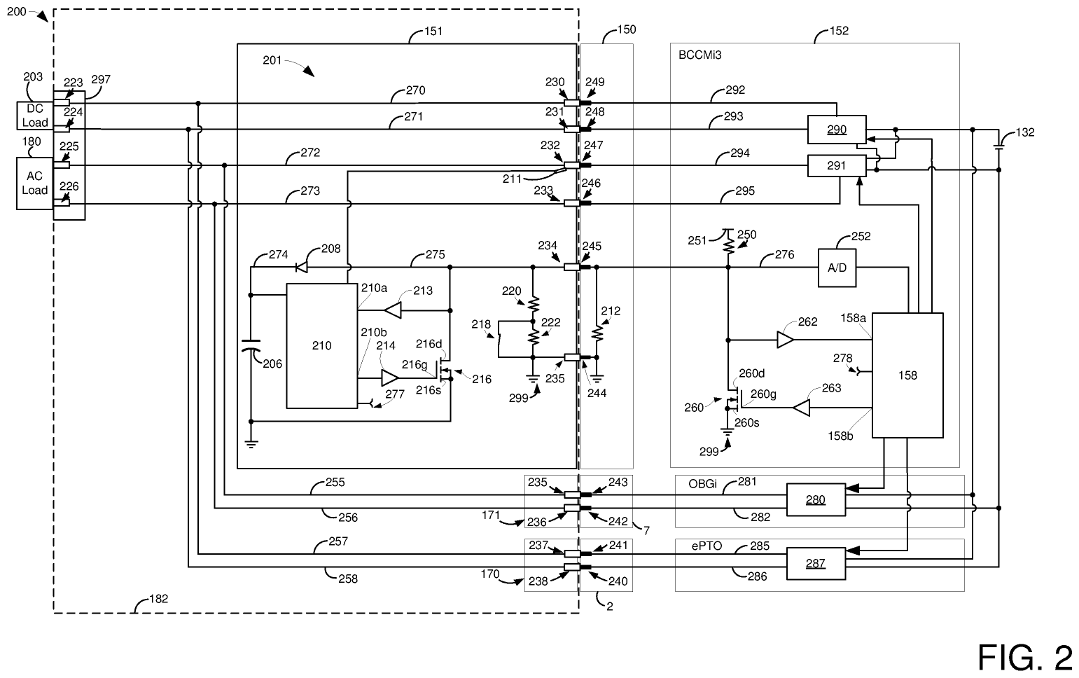

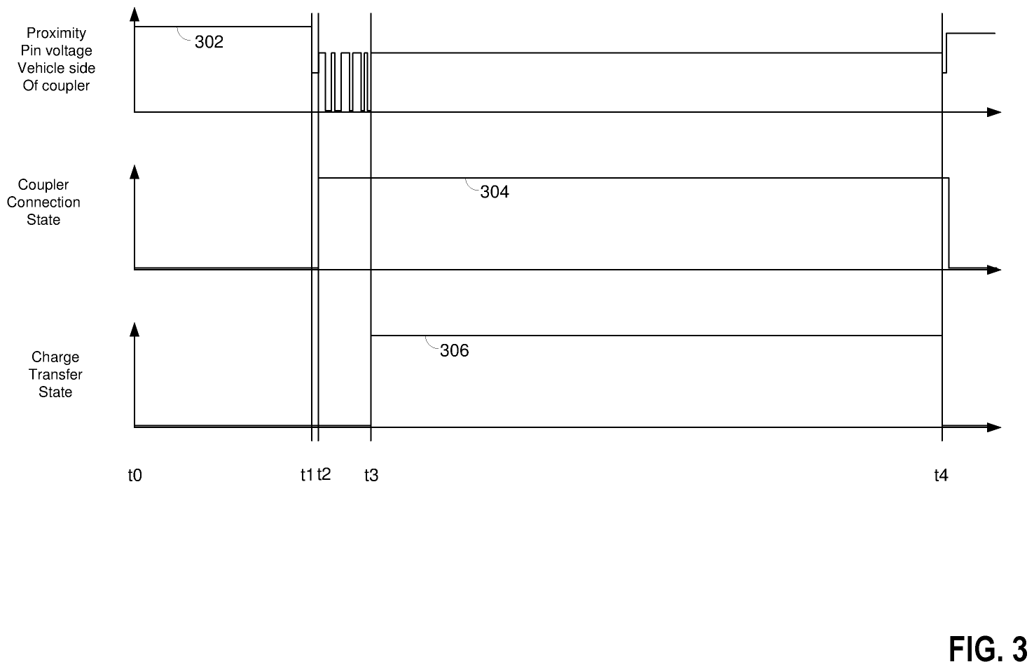

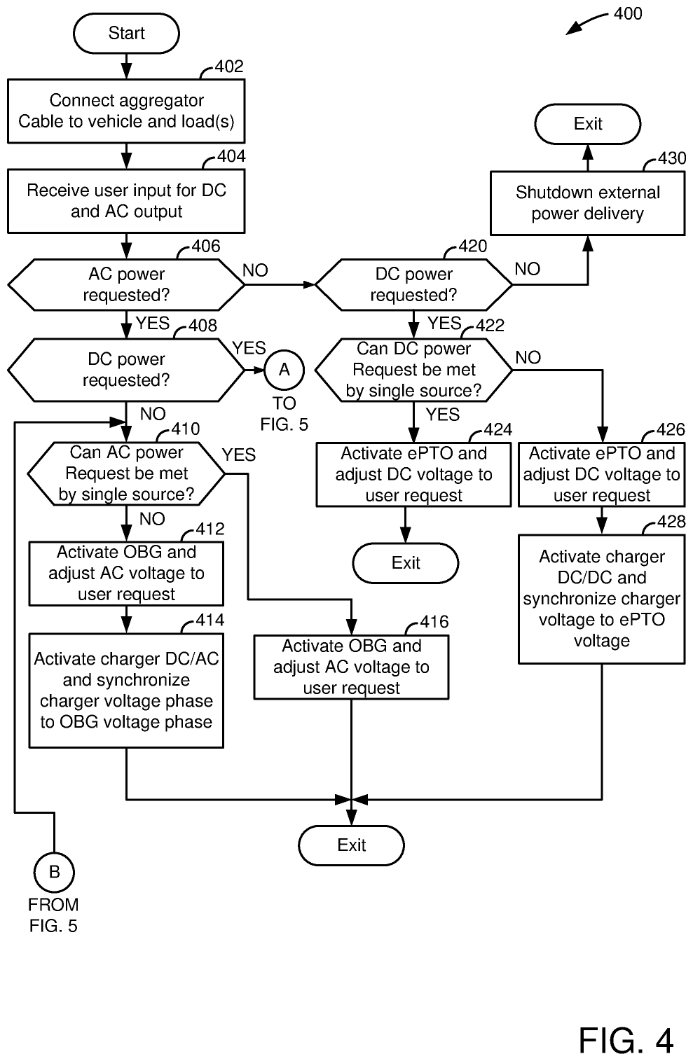

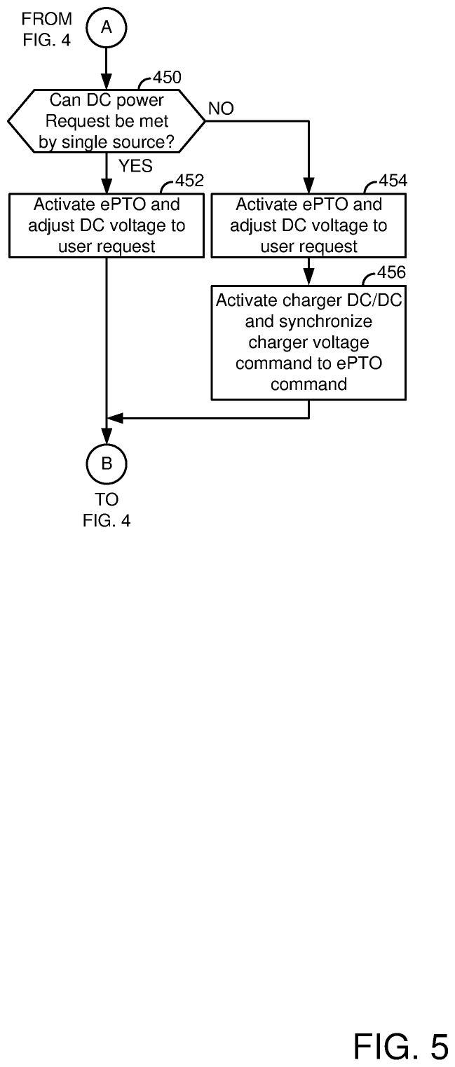

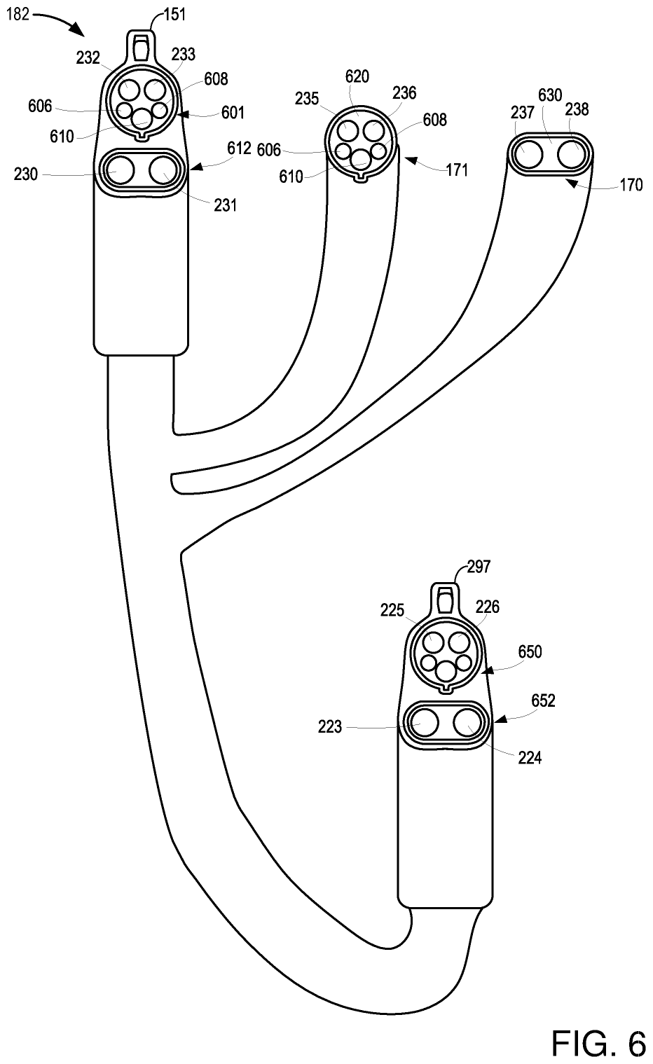

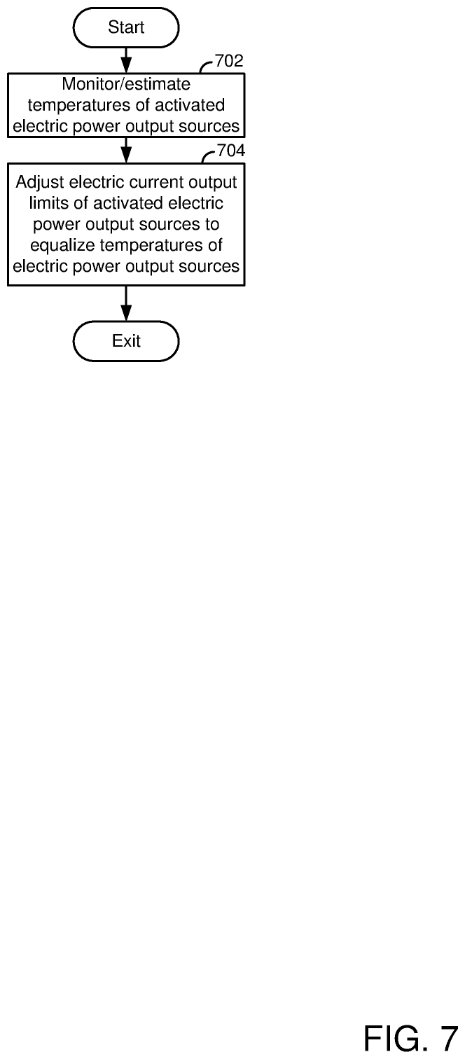

The following description relates to systems and methods for managing electric power delivery between a vehicle and an external device. FIG. 1 shows an example vehicle configuration that may exchange electrical power with an external device. A electric energy transmission cable and circuitry for transferring electric power from a vehicle to an external load is shown in FIG. 2. An example electric charge transfer sequence for an electric coupler is shown in FIG. 3. A method for supplying electric power to one or more external electric power consumers is shown in FIGS. 4 and 5. An example electric energy transmission cable is shown in FIG. 6 and a method for adjusting output of electric power sources is shown in FIG. 7.

An electric vehicle may include a plurality of electric power ports to import and export electric power to and from the electric vehicle. In one example, the electric vehicle may have a charging port that is configured to receive AC and/or DC power. Further, the electric vehicle may include an AC power output that may be used to supply AC electric power to power tools and other AC electric loads. In still other examples, an electric vehicle may include an electric power take off port that is configured to supply DC power to external vehicle loads. Each of these electric power ports may be adequate to supply commonly encountered electric loads. However, there may be times when a particular power port may not have capacity to supply a requested amount of electric power to an external electric power consumer. Therefore, it may be desirable to provide a way of supplying a greater amount of electric power to electric loads that are external to a vehicle.

The inventors herein have recognized the above-mentioned issues and have developed an electric energy transmission cable for an electric vehicle, comprising: at least two electric couplers configured to be coupled to an electric vehicle, the at least two electric couplers including a first electric coupler coupled to a first conductor and a second electric coupler coupled to a second conductor, the first conductor electrically coupled to the second conductor within the electric energy transmission cable.

By electrically coupling outputs of two different power sources of an electric vehicle via an electric energy transmission cable, it may be possible to increase electric output of an electric vehicle to an external electric load. For example, if an electric charger lacks capacity to provide an amount of electric power that is requested via an external power consumer, additional electric power may be delivered to the external power consumer via a second electric power source. Electric power supplied by both electric power sources may be combined via an electric power cable that aggregates electric power output from two different electric power sources. In this way, electric power may be supplied via two different power sources to meet electric power demand.

The present description may provide several advantages. In particular, the approach may increase power output capacity of an electric vehicle. Further, the approach may identify an electric energy transmission cable and adjust operation of two different electric power sources according to whether or not a known electric energy transmission cable has been electrically coupled to the vehicle so that a possibility of a power mismatch may be reduced. In addition, the approach may provide for supplying two different types of power (e.g., AC and DC) via three different power sources and a single electric energy transmission cable so that both AC and DC output power may be boosted.

FIG. 1 illustrates an example vehicle propulsion system 100 for vehicle 121. In this example, vehicle propulsion system 100 includes three electric machines that may be applied to propel vehicle 121. Throughout the description of FIG. 1, mechanical connections between various components are illustrated as solid lines, whereas electric connections between various components are illustrated as dashed lines.

In this example, vehicle propulsion system 100 includes an electric machine 153 coupled to solely one a wheel, namely left rear wheel 131lr. Vehicle propulsion system 100 also includes a second electric machine 127 that is coupled solely to one wheel, namely right real wheel 131rr. Vehicle propulsion system 100 drives front axle 133 and front wheels 130lf and 130rf via third electric machine 135. Front axle 133 is positioned toward front 108 of vehicle 121 and electric machines 153 and 127 are positioned toward rear 109 of vehicle 121. Thus, vehicle propulsion system 100 may be propelled by between one and three electric machines.

Electric machine 135, electric machine 127, and electric machine 153 are controlled via controller 12. The controller 12 (e.g., a centralized integrated vehicle control module) receives signals from the various sensors shown in FIG. 1. In addition, controller 12 employs the actuators shown in FIG. 1 to adjust driveline operation based on the received signals and instructions stored in memory of controller 12.

Vehicle propulsion system 100 has a front axle 133 and independently controlled rear wheels 131lr and 131rr. Vehicle propulsion system 100 further includes front wheels 130lf and 13rf. In this example, front wheels 130lf and 130rf and/or rear wheels 131lr and 131rr may be driven via electric propulsion sources. The front axle 133 is coupled to electric machine 135. Electric machine 135 is shown incorporated into front axle 133.

Electric machines 127, 153, and 135 may receive electrical power from onboard electric energy storage device 132. Furthermore, electric machines 127, 153, and 135 may provide a generator function to convert the vehicle's kinetic energy into electric energy, where the electric energy may be stored at electric energy storage device 132 for later use by the electric machine 127, 153, and/or 135. A first inverter system controller (ISC1) 137 may convert alternating current generated by electric machine 153 to direct current for storage at the electric energy storage device 132 and vice versa. First inverter system controller 137 may also convert direct current from electric energy storage device 132 into alternating current to power electric machine 153. A second inverter system controller (ISC2) 155 may convert alternating current generated by electric machine 127 to direct current for storage at the electric energy storage device 132 and vice versa. The second inverter system controller 155 may also convert alternating current generated by electric machine 127 to direct current for storage at the electric energy storage device 132 and vice versa. A third inverter system controller 147 may convert alternating current generated by electric machine 135 to direct current for storage at the electric energy storage device 132 and vice versa. Further, third inverter system controller 147 may convert direct current supplied by electric energy storage device 132 to power electric machine 135.

Electric energy storage device 132 may be a battery, capacitor, inductor, or other electric energy storage device. In some examples, electric energy storage device 132 may be configured to store electric energy that may be supplied to other electric loads residing on-board the vehicle (other than the motor), including cabin heating and air conditioning, vehicle starting, headlights, cabin audio and video systems, etc.

Control system 14 may communicate with one or more of electric machine 135, electric machine 153, electric machine 127, energy storage device 132, charge control module 152, electric power take off module 1, onboard generator module 4, etc., via a controller area network or other communications link. Control system 14 may receive sensory feedback information from one or more of electric machine 135, electric machine 127, electric machine 153, energy storage device 132, charge control module 152, electric power take off module 1, onboard generator module 4, etc., via a controller area network or other communications link. Further, control system 14 may send control signals to one or more of electric machine 135, electric machine 127, electric machine 153, energy storage device 132, charge control module 152, electric power take off module 1, onboard generator module 4, etc., responsive to this sensory feedback. Control system 14 may receive an indication of an operator requested output of the vehicle propulsion system from a human operator 102, or an autonomous controller. For example, control system 14 may receive sensory feedback from driver demand pedal position sensor 194 which communicates with driver demand pedal 192. Similarly, control system 14 may receive an indication of an operator requested vehicle slowing via a human operator 102, or an autonomous controller. For example, control system 14 may receive sensory feedback from left foot pedal position sensor 157 which communicates with left foot pedal 156.

Energy storage device 132 may periodically receive and/or deliver electric energy via external device 180 (e.g., an AC power source or consumer such as a stationary power grid, power tool, refrigeration unit, etc.) residing external to the vehicle (e.g., not part of the vehicle). As a non-limiting example, vehicle propulsion system 100 may be configured as a plug-in electric vehicle, whereby electric energy may be supplied to energy storage device 132 from external device 180 via an electric energy transmission cable 182 and electric coupler 151. During a charging or discharging operation of energy storage device 132 via external device 180, electric energy transmission cable 182 may electrically couple energy storage device 132 and external device 180. In some examples, external device 180 may be connected at electric port 150.

In some examples, electric energy from external device 180 may be received by charge control module 152. For example, charge control module 152 may convert alternating current from external device 180 to direct current (DC), for storage at electric energy storage device 132. Further, charge control module 152 may be bi-directional so as to convert DC from electric energy storage device 132 to AC for supply to external device 180. Further, charge control module 152 may step down or up DC voltage supplied from external device 180 to charge electric energy storage device 132. Additionally, charge control module 152 may step up or step down DC voltage from energy storage device 132 supplied to external device 180. Charge control module 152 may be controlled via its own dedicated controller 158 that includes non-transitory memory, a processor, inputs/outputs, and random access memory. Temperature of charge control module 152 may be inferred or monitored via temperature sensor 9.

Electric energy storage device 132 may also supply DC electric power to electric power take off module 1. Electric power take off module 1 may include a controller 3 with a processor, read-only memory, random access memory, and digital/analog inputs and outputs. Electric power take off module 1 includes a DC/DC converter that may increase or decrease voltage output of electric energy storage device 132 according to a requested DC voltage. The DC voltage may be output via outlet port 2 (e.g., third electric output port) to electric coupler 170. The DC power that is output via outlet port 2 may be combined with DC power that is output via charge control module 152 at electric energy transmission cable 182. Temperature of power take off module 1 may be inferred or monitored via temperature sensor 10.

Electric energy storage device 132 may also supply DC electric power to onboard generator module 4. Onboard generator module 4 may include a controller 5 with a processor, read-only memory, random access memory, and digital/analog inputs and outputs. Onboard generator module 4 includes a DC/AC converter that may output a requested AC voltage (e.g., 120 VAC/240 VAC). The AC voltage may be output via outlet port 7 (e.g., second electric output port) to electric coupler 171. The AC power that is output via outlet port 7 may be combined with AC power that is output via charge control module 152 at electric energy transmission cable 182. Temperature of onboard generator module 4 may be inferred or monitored via temperature sensor 11.

While the vehicle propulsion system is operated to propel the vehicle, electric energy transmission cable 182 may be disconnected between external device 180 and energy storage device 132. Control system 14 may identify and/or control the amount of electric energy stored at the energy storage device 132, which may be referred to as the state of charge (SOC).

Energy storage device 132 may include an electric energy storage device controller 139. Electric energy storage device controller 139 may provide charge balancing between energy storage element (e.g., battery cells) and communication with other vehicle controllers (e.g., controller 12).

One or more wheel speed sensors (WSS) 195 may be coupled to one or more wheels of vehicle propulsion system 100. The wheel speed sensors may detect rotational speed of each wheel. Such an example of a WSS may include a permanent magnet type of sensor.

Vehicle propulsion system 100 may further include an rate of change of velocity sensor 20. Additionally, vehicle propulsion system 100 may further include an inclinometer 21. Vehicle propulsion system 100 may also include a steering control system 176 that may adjust a steering angle via adjusting a position of steering motor 177.

Vehicle propulsion system 100 may further include a caliper system control module (SCM) 141 to apply and release friction wheel calipers 142. In some examples, SCM 141 may comprise an anti-lock system, such that tires (e.g., 130t and 131t) of wheels (e.g. 130lf, 130rf, 131lr, and 131rr) may maintain tractive contact with the road surface according to driver inputs while slowing, which may thus prevent the wheels from locking up, to prevent skidding. In some examples, SCM 141 may receive input from wheel speed sensors 195.

Vehicle propulsion system 100 may further include a motor electronics coolant pump (MECP) 146. MECP 146 may be used to circulate coolant to diffuse heat generated by at least electric machine 127, electric machine 153, and electric machine 135 of vehicle propulsion system 100, and the electronics system. MECP may receive electrical power from onboard energy storage device 132, as an example.

Controller 12 may comprise a portion of a control system 14. In some examples, controller 12 may be a single controller of the vehicle. Control system 14 is shown receiving information from a plurality of sensors 16 (various examples of which are described herein) and sending control signals to a plurality of actuators 81 (various examples of which are described herein). As one example, sensors 16 may include tire pressure sensor(s) 197, wheel speed sensor(s) 195, etc. In some examples, steering angle sensor 175, sensors associated with electric machine 135, electric machine 127, and electric machine 153, etc., may communicate information to controller 12, regarding various states of electric machine operation.

Vehicle propulsion system 100 may also include an on-board navigation system 17 (for example, a Global Positioning System) on dashboard 19 that an operator of the vehicle may interact with. The navigation system 17 may include one or more location sensors for assisting in estimating a location (e.g., geographical coordinates) of the vehicle. For example, on-board navigation system 17 may receive signals from GPS satellites (not shown), and from the signal identify the geographical location of the vehicle. In some examples, the geographical location coordinates may be communicated to controller 12.

Dashboard 19 may further include a display system 18 configured to display information to the vehicle operator. Display system 18 may comprise, as a non-limiting example, a touchscreen, or human machine interface (HMI), display which enables the vehicle operator to view graphical information as well as input commands. In some examples, display system 18 may be connected wirelessly to the internet (not shown) via controller (e.g. 12). As such, in some examples, the vehicle operator may communicate via display system 18 with an internet site or software application (app).

Dashboard 19 may further include an operator interface 15 via which the vehicle operator may adjust the operating status of the vehicle. Specifically, the operator interface 15 may be configured to initiate and/or terminate operation of the vehicle driveline (e.g., electric machine 135, electric machine 127, and electric machine 153) based on an operator input. Further, via operator interface 15 or display system 18, a user may request AC, DC, AC and DC output power from charge control module 152, electric power take off module 1, and onboard generator module 4. Various examples of the operator interface 15 may include interfaces that apply a physical apparatus, such as an active key, that may be inserted into the operator interface 15 to activate electric machines 135, 127, and 153, or may be removed to shut down the electric machines 135, 127, and 153 to turn off the vehicle. Still other examples, a start/stop button that is manually pressed by the operator may be applied to start or shut down the vehicle. In other examples, a remote vehicle start may be initiated remote computing device 111 (e.g., a cellular phone, etc.), for example a cellular telephone, or smartphone-based system where a user's cellular telephone sends data to a server and the server communicates with the vehicle controller 12 to start the vehicle.

Referring now to FIG. 2, a schematic 200 of an example electric energy transmission cable 182 that includes a circuit 201 for communicating capacity of one or more electric couplers and the electric energy transmission cable to a vehicle is shown. Schematic 200 includes first external device 180 (e.g., an AC electrical load), second external electric load 203 (e.g., an optional DC electrical load), first electric coupler 151, first electric port 150 (e.g., a receptacle), charge control module 152, second electric coupler 171, electric port 7, onboard generator module 280, third electric coupler 170, electric port 2, and electric power take off module 287.

Within first electric coupler 151, circuitry 201 for identifying and transmitting cable and electric coupler operating conditions and limitations to a vehicle is shown. In particular, electric coupler 151 includes sockets 230-235 that are configured to interface with pins 244-249 of first electric port 150. It is to be understood that sockets may be exchanged for pins and vise-versa. Circuitry 201 also includes a controller 210 (e.g., a microcontroller that may include a processor, non-transitory memory, random access memory, digital inputs/outputs, analog inputs/outputs), a capacitor 206, diode 208, buffers 213 and 214, optional transmitter 277, transistor 216, switch 218, temperature sensor 211, and a voltage divider circuit comprising resistor 220 and resistor 222.

Controller 210 is supplied with electrical power when electric coupler 151 is mated with first electric port 150 via power supply 251 (e.g., 5 VDC). Pin 245 and socket 234 (e.g., proximity pilot pin/socket) may be referred to as proximity pins because they may carry a voltage (e.g., a proximity voltage) that may be indicative of the proximity of electric coupler 151 relative to first electric port 150. In particular, voltage generated via power supply 251 may be reduced to a value at electric conductor 276, electric conductor 275, socket 234, and pin 245 that may be indicative of a predetermined cable/electric coupler identity as function of the resistance values of resistors 250, 212, and 220 when electric coupler 151 is fully engaged with electric port 150. For example, a proximity voltage of 4.0 volts may indicate that the cable and electric coupler is configured to discharge 10 KW while a proximity voltage of 2.5 volts may indicate that the cable and electric coupler is configured to discharge 19 kW from the vehicle. The voltage at electric conductor 276, electric conductor 275, socket 234, and pin 245 (e.g., the proximity voltage) may be reduced from the level of the voltage produced by power supply 251 via each of resistors 250 and 220 when first electric coupler 151 is fully engaged with first electric port 150, which closes switch 218 to bypass resistor 222 as shown. However, if first electric coupler 151 begins to be removed from first electric port 150, switch 218 opens so that the voltage at electric conductor 276, electric conductor 275, socket 234, and pin 245 (e.g., the proximity voltage) is now a function of the resistance values of resistors 250, 220, 212, and 222.

Power that is supplied by power supply 251 to capacitor 206 and controller 210 is supplied at a voltage that is equal to the voltage output of power supply 251 minus the voltage drop across resistor 250 minus the voltage drop across diode 208. Diode 208 allows electric charge to flow to capacitor 206 from power supply 251 when electric coupler 151 is fully engaged to electric port 150. Diode 208 prevents capacitor 206 from discharging through resistor 220 and/or transistor 216. Electric conductor 274 carries electric charge from diode 208 to capacitor 206. Controller 210 may determine whether the voltage at electric conductor 275, voltage at electric conductor 276, voltage at socket 234, and voltage at pin 245, which may be expected to be equivalent when electric coupler 151 is fully engaged with electric port 150, is a high or low level via digital input 210a. Buffer 213 may adjust the level of the proximity voltage (e.g., the voltage at electric conductor 275, voltage at electric conductor 276, voltage at socket 234, and voltage at pin 245) so that it is compatible with digital input 210a. Controller 210 may toggle the proximity voltage (e.g., voltage at electric conductor 275, voltage at electric conductor 276, voltage at socket 234, and voltage at pin 245 when electric coupler 151 is fully engaged with electric port 150) between a high level and a low level via digital output 210b driving buffer 214. Buffer 214 in turn may drive transistor 216 (e.g., an N-channel field effect resistor) to open and close operating as a switch in response to output of digital output 210b. For example, when gate 216g of transistor 216 is supplied with a higher voltage (e.g., >3.5 volts), transistor 216 may close to pull the proximity voltage and voltage at drain 216d close to ground (e.g., less than 0.5 volts) since source 216s is directly electrically coupled to ground. On the other hand, when gate 216g is supplied with a lower voltage (e.g., <0.5 volts), transistor 216 may be held open so that proximity voltage is determined by resistor 250, resistor 220, and resistor 212. Thus, controller 210 may selectively open and close transistor 216 to change the proximity voltage.

The proximity voltage may be used for serial communication between controller 210 and controller 158. Capacitor 206 supplies controller 210 with power when the proximity voltage is driven low by closing transistor 216. Thus, controller 210 is powered by the vehicle and may power up when electric coupler 151 is engaged with electric port 150.

In another representation, controller 210 may transmit or broadcast a radio frequency signal via transmitter 277 when electric coupler 151 is engaged with first electric port 150. Controller 210 may broadcast the cable and electric coupler voltage capacity limits (e.g., maximum voltage that may be transferred via the cable and coupling), current capacity limits (e.g., maximum current that may be transferred via the cable and coupling), temperatures of the cable and coupling, cable configuration (e.g., one or more input electric couplers and one or more output electric couplers), and other manufacturing information and operating conditions via the signal.

First electric coupler 151 and its associated electric energy transmission cable may carry or deliver AC power to an external device 180 (e.g., an AC power consumer) via electric conductor 272, electric conductor 273, and sockets 232 and 233. Further, in some examples, electric coupler 151 and its associated transmission cable may carry or deliver DC power to a second external electric load 203 (e.g., a DC power consumer) via electric conductor 270, electric conductor 271, and sockets 230 and 231.

Conductor 255 may be electrically coupled to conductor 272 and conductor 256 may be electrically coupled to conductor 273 so that AC power generated via onboard generator module 280 may be combined with AC power generated via bidirectional AC/DC converter 291 of charge control module 152. Power produced by onboard generator module 280 may be transferred via sockets 235 and 236 and pins 242 and 243.

Conductor 257 may be electrically coupled to conductor 270 and conductor 258 may be electrically coupled to conductor 271 so that DC power generated via electric power take off module 287 may be combined with DC power generated via bi-directional DC/DC converter 290 of charge control module 152. Power produced by electric power take off module 287 may be transferred via sockets 237 and 238 and pins 241 and 240.

Controller 158 of charge control module 152 may also communicate via a serial link that is formed by the level of the proximity voltage that may be carried or delivered via electric conductor 276 and electric conductor 275. Controller 158 may sense the level of the proximity voltage that may be carried or supplied by electric conductor 275 and electric conductor 276 via analog to digital (A/D) converter 252. Buffer 262 may adjust the level of the proximity voltage (e.g., the voltage at electric conductor 275, voltage at electric conductor 276, voltage at socket 234, and voltage at pin 245) so that it is compatible with digital input 158a. Controller 158 may toggle the proximity voltage (e.g., voltage at electric conductor 275, voltage at electric conductor 276, voltage at socket 234, and voltage at pin 245 when electric coupler 151 is fully engaged with first electric port 150) between a high level and a low level via digital output 158b driving buffer 263. Buffer 263 in turn may drive transistor 260 (e.g., an N-channel field effect resistor) to open and close operating as a switch in response to output of digital output 158b. On the other hand, when gate 260g is supplied with a lower voltage (e.g., <0.5 volts), transistor 260 may be held open so that proximity voltage is determined by resistor 250, resistor 220, and resistor 212. Thus, controller 158 may selectively open and close transistor 260 to change the proximity voltage. The proximity voltage may be used for serial communication between controller 210 and controller 158.

In another representation, controller 158 may receive data communicated by controller 210 and broadcast via radio frequency via receiver 278. As previously, mentioned the data may include electric coupler power limits, temperatures, and other data. Controller 158 may start to receive data as soon as electric coupler 151 is fully engaged with electric port 150. First electric port 150 is integral with the vehicle and it is not an external device.

DC to DC converter 290 may boost (increase), or in the alternative, buck (reduce) voltage output via electric energy storage device 132 (e.g., traction battery) for delivery to second external electric load 203. Conductor 292 and conductor 293 may supply DC power to second external electric load 203 via pins 249 and 248. Bidirectional AC/DC converter 291 may convert DC power supplied by electric energy storage device 132 to AC power for external device 180. Conductor 294 and conductor 295 may supply AC power to external device 180 via pins 246 and 247. Controller 158 may activate and control power output of DC to DC converter 290 and bidirectional AC/DC converter 291 in response to data received from controller 210. Electric output coupler 297 may supply DC power to second external electric load 203 and AC power to external device 180.

Referring now to FIG. 3, an example sequence where a power transfer cable and electric coupler is coupled to a vehicle is shown. The sequence of FIG. 3 may be generated via the system of FIGS. 1, 2, and 6 in cooperation with the method of FIGS. 4 and 5.

The first plot from the top of FIG. 3 is a plot of a proximity pin voltage on a vehicle side of an electric coupler to vehicle connection versus time. The vertical axis represents proximity pin voltage (e.g., a voltage at a proximity pin of the electric coupler) and the voltage increases in the direction of the vertical axis arrow. The horizontal axis represents time and time increases from the left side of the figure to the right side of the figure. Trace 302 represents the proximity pin voltage.

The second plot from the top of FIG. 3 is a plot of electric coupler connection or engagement state with an electric port of a vehicle versus time. The vertical axis represents the connection state of the electric coupler and the electric coupler is fully engaged to the electric port of the vehicle when trace 304 is near the vertical axis arrow. The electric coupler is not fully engaged with the electric port of the vehicle when trace 304 is near the horizontal axis. Trace 304 represents the electric coupler engagement state.

The third plot from the top of FIG. 3 is a plot of charge transfer state versus time. The vertical axis represents charge transfer state (e.g., whether or not the cable and electric coupler are transferring power or charge) and charge or electric power is being transferred via the electric coupler when trace 306 is at a level that is near the vertical axis arrow. The electric coupler is not transferring charge or power when trace 306 is at a lower level near the horizontal axis. Trace 306 represents the state of transfer of charge or power via the electric coupler and its associated cable.

At time t0, the proximity pin voltage is at a higher level to indicate that no electric coupler is coupled to the vehicle's electric port. The connection state indicates that there is no full connection between the electric coupler and the vehicle's electric port. Further, there is no charge or power transfer via the cable and electric coupler.

At time t1, the electric coupler begins to be inserted into the vehicle's electric port and the proximity pin voltage is lowered. The connection state indicates that there is no full connection between the electric coupler and the vehicle's electric port. Additionally, there is no charge or power transfer via the cable or electric coupler to an external load.

At time t2, the electric coupler is fully engaged with the vehicle input port and the proximity pin voltage changes to reflect the engagement. Shortly thereafter, the proximity voltage begins to toggle or switch between low voltage and a higher voltage to begin serial communication between the electric coupler controller and the charger controller. First, the charger controller requests data and then the electric coupler controller responds to the request. The data exchange ends at time t3 and the charger begins to allow electric power to be transferred from the vehicle to an external device. The charger may command and control the voltage and current that is output to the electric coupler and the external device.

At time t4, the electric power transfer is completed when a user begins to remove the electric coupler from the vehicle's electric port. The user depresses a button, which causes the proximity pin voltage to change. The charger commands the electric power transfer to cease and the electric power transfer is ended before the electric coupler is fully decoupled from the vehicle's electric port.

In this way, electric coupler data may be communicated to a vehicle via a serial communications link that increases the functionality of the proximity pin voltage. The serial communication is bidirectional allowing the charger to issue commands and allowing the electric coupler to respond to the commands.

Referring now to FIGS. 4 and 5, an example method for supplying electric power via an electric vehicle is shown. Additionally, the method may operate the electric vehicle while delivering electric power via the electric vehicle. The method of FIGS. 4 and 5 may be incorporated into and may cooperate with the systems of FIGS. 1, 2, and 6. Further, at least portions of the method of FIGS. 4 and 5 may be incorporated as executable instructions stored in non-transitory memory of one or more controllers while other portions of the method may be performed via the one or more controllers transforming operating states of devices and actuators in the physical world.

At 402, method 400 includes connecting an electric energy transmission cable (e.g., an aggregation cable) to an electric vehicle and a load that is external to the electric vehicle. Note that the external load may be an electric load that is transported via the vehicle, such as a cooler. The connection of the electric energy transmission cable to the electric load or loads and the electric vehicle may be made via a human or an automated system. Method 400 proceeds to 404.

At 404, method 400 receives input from a user or an automated system to request a rate of power delivery to provide external to the electric vehicle. The input may include one or more of an AC voltage request, a DC voltage request, and AC current request, a DC current request, AC output power request, and DC output power request. In one example, the input may be provided via a human/machine interface, which may include a phone or computer. In some examples, the user may be prompted for the requested input in response to the electric energy transmission cable being electrically coupled to the electric vehicle. Method 400 proceeds to 406.

At 406, method 400 judges whether or not AC power has been requested. If so, the answer is yes and method 400 proceeds to 408. Otherwise, the answer is no and method 400 proceeds to 420.

At 420, method 400 judges whether or not DC power has been requested. If so, the answer is yes and method 400 proceeds to 422. Otherwise, the answer is no and method 400 proceeds to 430.

At 430, method 400 shuts down delivery of electric power to devices that are external from the vehicle. Method 400 may command the charger, the electric power take off, and the onboard power off so that electric power is not delivered to the electric ports. Method 400 proceeds to exit.

At 422, method 400 judges whether or not the amount of DC power that has been requested by the user may be met via a single DC power source (e.g., the electric power take off module (ePTO)). If so, the answer is yes and method 400 proceeds to 424. Otherwise, the answer is no and method 400 proceeds to 426. Method 400 may judge whether or not the amount of DC power requested may be provided by a single DC power source by determining if the power output capacity of the first DC power source is greater than the amount of DC power requested. If so, and if the first DC power source may deliver the requested amount of DC power at an efficient operating condition, method 400 may deliver the requested DC power amount via the first DC power source.

At 424, method 400 activates and commands a first DC power source (e.g., the electric power take off module (ePTO)) to a voltage and power output level that has been requested by the user. The electric power take off delivers the requested DC power to the electric energy transmission cable 182 and the electric energy transmission cable delivers the DC power to a DC power consumer. Method 400 proceeds to exit.

At 426, method 400 activates the first DC power source (e.g., the electric power take off module) and adjusts the voltage of the electric power take off to the requested DC voltage. The first DC power source may also be commanded to provide a first portion of the requested amount of DC power. In one example, the first portion of the requested amount of DC power is an output power amount where the operating efficiency of the first DC power supply is greater than a first threshold efficiency level. Method 400 proceeds to 428.

At 428, method 400 activates the second DC power source (e.g., the charger) and adjusts the voltage of the charger to the voltage that is output via the first DC power source, or alternatively, to the requested DC voltage. The second DC power source may also be commanded to provide a second portion of the requested amount of DC power. In one example, the second portion of the requested amount of DC power is equal to the requested DC power minus the output power amount of the first DC power source. Method 400 proceeds to exit.

At 408, method 400 judges whether or not the user has requested DC power output in addition to AC power output. If so, the answer is yes and method 400 proceeds to 450 of FIG. 5. If not, the answer is no and method 400 proceeds to 410.

At 450, method 400 judges whether or not the amount of DC power that has been requested by the user may be met via a single DC power source (e.g., the electric power take off module (ePTO)). If so, the answer is yes and method 400 proceeds to 452. Otherwise, the answer is no and method 400 proceeds to 454.

At 452, method 400 activates and commands a first DC power source (e.g., the electric power take off module (ePTO)) to a voltage and power output level that has been requested by the user. The electric power take off delivers the requested DC power to the electric energy transmission cable 182 and the electric energy transmission cable delivers the DC power to a DC power consumer. Method 400 proceeds to exit.

At 454, method 400 activates the first DC power source (e.g., the electric power take off module) and adjusts the voltage of the electric power take off to the requested DC voltage. The first DC power source may also be commanded to provide a first portion of the requested amount of DC power. In one example, the first portion of the requested amount of DC power is an output power amount where the operating efficiency of the first DC power supply is greater than a first threshold efficiency level. Method 400 proceeds to 456.

At 456, method 400 activates the second DC power source (e.g., the charger) and adjusts the voltage of the charger to the voltage that is output via the first DC power source, or alternatively, to the requested DC voltage. The second DC power source may also be commanded to provide a second portion of the requested amount of DC power. In one example, the second portion of the requested amount of DC power is equal to the requested DC power minus the output power amount of the first DC power source. Method 400 returns to 410.

At 410, method 400 judges whether or not the amount of AC power that has been requested by the user may be met via a single AC power source (e.g., the onboard generator module (OBG)). If so, the answer is yes and method 400 proceeds to 416. Otherwise, the answer is no and method 400 proceeds to 412. Method 400 may judge whether or not the amount of AC power requested may be provided by a single AC power source by determining if the power output capacity of the first AC power source is greater than the amount of AC power requested. If so, and if the first AC power source may deliver the requested amount of AC power at an efficient operating condition, method 400 may deliver the requested AC power amount via the first AC power source.

At 416, method 400 activates and commands a first AC power source (e.g., the onboard generator (OBG)) to a voltage (e.g., 120 or 240 volts AC) and power output level that has been requested by the user. The onboard generator module delivers the requested AC power to the electric energy transmission cable 182 and the electric energy transmission cable delivers the AC power to a AC power consumer. Method 400 proceeds to exit.

At 412, method 400 activates the first AC power source (e.g., the onboard generator module) and adjusts the voltage of the onboard generator the requested AC voltage. The first AC power source may also be commanded to provide a first portion of the requested amount of AC power. In one example, the first portion of the requested amount of AC power is an output power amount where the operating efficiency of the first AC power supply is greater than a first threshold efficiency level. Method 400 proceeds to 414.

At 414, method 400 activates the second AC power source (e.g., the charger) and adjusts the voltage of the charger to match the voltage and voltage phase that is output via the first AC power source. The second AC power source may also be commanded to provide a second portion of the requested amount of AC power. In one example, the second portion of the requested amount of AC power is equal to the requested AC power minus the output power amount of the first AC power source. Method 400 may monitor voltage output of the first AC source and adjust the phase voltage of the second AC source to match the voltage of the first AC source. For example, if the first AC power source outputs a first voltage at a first phase angle, then the second power source output voltage is adjusted to match the first voltage at the first phase angle. Method 400 proceeds to exit.

The method of FIGS. 4 and 5 provides for a method for supplying electric power from an electric vehicle, comprising: coupling a first electric coupler and a second electric coupler to the electric vehicle; coupling a third electric coupler to an electrical load external from the electric vehicle; and supplying electric power to the external load via flowing electric current from the first electric coupler and the second electric coupler to the third electric coupler. In a first example, the method includes where a first conductor is electrically coupled to the first electric coupler, and where a second conductor is electrically coupled to the second electric coupler. In a second example that may include the first example, the method includes where the first conductor is electrically coupled to the second conductor. In a third example that may include one or both of the first and second examples, the method includes where the first electric coupler and the second electric coupler are part of an electric energy transmission cable, and further comprises: transmitting identification data for the electric energy transmission cable to the vehicle. In a fourth example that may include one or more of the first through third examples, the method includes where the electric power is direct current electric power. In a fifth example that may include one or more of the first through fourth examples, the method includes where the electric power is alternating current electric power. In a sixth example that may include one or more of the first through fifth examples, the method includes where the electric power is supplied via a single battery, where the single battery is a traction battery.

The method of FIGS. 4 and 6 also provides for a method for supplying electric power from an electric vehicle, comprising: coupling a first electric coupler and a second electric coupler to the electric vehicle; coupling a third electric coupler to an electrical load external from the electric vehicle; and supplying electric power to the external load via flowing electric current from a first power source through the first electric coupler and from a second power source through the second electric coupler to the third electric coupler, the first power source different from the second power source. In a first example, the method includes where the first power source and the second power source are alternating current power sources. In a second example that may include the first example, the method includes where the first power source is a leading power source and the second power source is a secondary power source, where a phase of voltage output of the second power source is synchronized with a phase of voltage output via the first power source. In a third example that may include one or both of the first and second examples, the method includes where the first power source is a leading power source and the second power source is a secondary power source, where a voltage output of the second power source is synchronized with a voltage output via the first power source, and where the first power source and the second power source are direct current power sources. In a fourth example that may include one or more of the first through third examples, the method further comprises communicating electric energy transmission cable data from the first electric coupler to the electric vehicle. Additionally, the methods described herein provide for adjusting a maximum electric current output of either the first power source or the second power source in response to a temperature of either the first power source or the second power source.

Referring now to FIG. 6, a view of an example electric energy transmission cable 182 is shown. In this example, electric energy transmission cable 182 includes electric couplers 151, 171, and 170 that may be coupled to a sole vehicle 121 shown in FIG. 1. Electric energy transmission cable 182 also includes electric output coupler 297 that may be coupled to one or more electric loads. Electric output coupler 297 includes socket 223 and socket 224 to interface with second external electric load 203. Electric output coupler 297 also includes socket 225 and socket 226 to interface with first external device 180. It is to be understood that electric energy transmission cable 182 may have additional or fewer electric couplers to couple to a single or sole electric vehicle. Further, electric energy transmission cable 182 may deliver electric energy to one or more electric power consumers via one or more electric couplers. As such, the configuration of electric energy transmission cable 182 shown in FIG. 6 is non-limiting.

Electric coupler 151 is shown including an electrical connector 601 (e.g., a society of automotive engineers (S.A.E.) J1772 connector) that may include pins/sockets to carry or transfer electric power from/to a vehicle to/from an external load/source. AC power may be carried and/or transferred via the electrical connector. Optionally, electric coupler 151 may include a second connector 612 for carrying or transmitting DC electric power (e.g., for DC fast charging/discharging).

In this example, electric energy transmission cable 182 is configured with three electric couplers for coupling to an electric vehicle. In particular, electrical connector 601 includes a first AC L1 socket 232, a second AC neutral or L2 socket 233, ground socket 610, proximity pilot socket 234, and control pilot socket 608. Connector 612 includes a DC+socket 230 and DC-socket 231. Electric coupler 171 is also shown with an electrical connector 620. Electrical connector 620 includes a first AC L1 socket 235, a second AC neutral or L2 socket 236, ground socket 610, proximity pilot socket 606, and control pilot socket 608. Electric coupler 170 is also shown with an electrical connector 630. Electrical connector 630 includes a DC+socket 237 and a DC-socket 238.

The present example also includes an electric output coupler 297 to couple to an electric power consumer (not shown). Electric output coupler 297 includes a first connector 650 including socket 225 and socket 226 for interfacing with AC electric loads. Further, electric output coupler 297 includes a second connector 652 including socket 223 and socket 224 for interfacing with DC electric loads.

Thus, the system of FIGS. 1, 2, and 6 provides for an electric energy transmission cable for an electric vehicle, comprising: at least two electric couplers configured to be coupled to an electric vehicle, the at least two electric couplers including a first electric coupler coupled to a first conductor and a second electric coupler coupled to a second conductor, the first conductor electrically coupled to the second conductor within the electric energy transmission cable. In a first example, the electric energy transmission cable includes where the at least two electric couplers are configured to transfer alternating current. In a second example that may include the first example, the electric energy transmission cable includes where the at least two electric couplers are configured to transfer direct current. In a third example that may include one or both of the first and second examples, the electric energy transmission cable further comprises a third electric coupler configured to couple to an electric load. In a fourth example that may include one or more of the first through third examples, the electric energy transmission cable further comprises a fourth electric coupler configured to couple to the electric vehicle. In a fifth example that may include one or more of the first through fourth examples, the electric energy transmission cable further comprises a third conductor electrically coupled to the fourth electric coupler. In a sixth example that may include one or more of the first through fifth examples, the electric energy transmission cable further comprises a fourth conductor electrically coupled to the first electric coupler, the fourth conductor electrically coupled to the third conductor. In a seventh example that may include one or more of the first through sixth examples, the electric energy transmission cable includes where the first conductor and the fourth conductor are electrically coupled to the third electric coupler.

Referring now to FIG. 7, an example method for adjusting output current of one or more devices supplying power from onboard a vehicle to off board the vehicle is shown. The method of FIG. 7 may be incorporated into and may cooperate with the systems of FIGS. 1, 2, and 6. Further, at least portions of the method of FIG. 7 may be incorporated as executable instructions stored in non-transitory memory of one or more controllers while other portions of the method may be performed via the one or more controllers transforming operating states of devices and actuators in the physical world. Further still, the method of FIG. 7 may be performed contemporaneously with the method of FIGS. 4 and 5.

At 702, method 700 monitors and/or infers temperatures of one or more devices that supply electric power off board the vehicle. The temperatures may be indicative of loads that are applied to the devices that are supplying electric power off board the vehicle. For example, method 700 may estimate or measure a temperature of charge control module 152, power take off module 1, and onboard generator module 4. Method 700 proceeds to 704.

At 704, method 700 may dynamically adjust a maximum amount of current (e.g., a current limit or threshold level) for one or more of the devices that supply electric power off board the vehicle in response to temperatures of the one or more devices that supply electric power off board the vehicle. Each of the devices that supply electric power off board the vehicle may have its own individual maximum amount of current. The maximum amount of currents for each of the devices supplying electric power off board the vehicle may be adjusted so that temperatures of the devices supplying electric power off board the vehicle are equalized (e.g., within +5% of each other). In one example, a proportional/integral/derivative (PID) controller may adjust the maximum current output of one or more of the devices based on a present temperature of the device supplying electric power off board the vehicle with respect to a maximum design temperature for the device supplying electric power off board the vehicle. For example, if a temperature of a first device is approaching the maximum temperature of the first device, the maximum current output of the first device may be decreased so that the first device may have an opportunity to cool while output of a second device is increased to meet the electric power demand. While operating at high power usage continuous operation, electric load sharing may automatically bias the more capable/lower temperature device.

In an alternative representation, if a temperature of a first device is approaching the maximum temperature of the first device, the maximum current output of a second device may be adjusted so that the first device may have an opportunity to cool thereby allowing output of the second device may be adjusted to meet the electric power demand. Method 700 proceeds to exit.

Note that the example control and estimation routines included herein can be used with various vehicle and powertrain configurations. The control methods and routines disclosed herein may be stored as executable instructions in non-transitory memory and may be carried out by the control system including the controller in combination with the various sensors, actuators, and other vehicle hardware.

Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example examples described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the vehicle control system, where the described actions are carried out by executing the instructions in a system including the various vehicle hardware components in combination with the electronic controller. One or more of the method steps described herein may be omitted if desired.

It will be appreciated that the configurations and routines disclosed herein are exemplary in nature, and that these specific examples are not to be considered in a limiting sense, because numerous variations are possible. For example, the above technology may be applied to electric energy transmission cables having different numbers of pins/socket, different connector types, and different couplers than are shown and described herein.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric energy transmission cable for an electric vehicle, comprising:
at least two electric couplers configured to be coupled to the electric vehicle, the at least two electric couplers including a first electric coupler coupled to a first conductor and a second electric coupler coupled to a second conductor, the first conductor electrically coupled to the second conductor within the electric energy transmission cable.

2. The electric energy transmission cable of claim 1, where the at least two electric couplers are configured to transfer alternating current.

3. The electric energy transmission cable of claim 1, where the at least two electric couplers are configured to transfer direct current.

4. The electric energy transmission cable of claim 1, further comprising a third electric coupler configured to couple to an electric load.

5. The electric energy transmission cable of claim 4, further comprising a fourth electric coupler configured to couple to the electric vehicle.

6. The electric energy transmission cable of claim 5, further comprising a third conductor electrically coupled to the fourth electric coupler.

7. The electric energy transmission cable of claim 6, further comprising a fourth conductor electrically coupled to the first electric coupler, the fourth conductor electrically coupled to the third conductor.

8. The electric energy transmission cable of claim 7, where the first conductor and the fourth conductor are electrically coupled to the third electric coupler.

9. A method for supplying electric power from an electric vehicle, comprising:
coupling a first electric coupler and a second electric coupler to the electric vehicle;
coupling a third electric coupler to an electric load external from the electric vehicle; and
supplying electric power to the electric load via flowing electric current from the first electric coupler and the second electric coupler to the third electric coupler.

10. The method of claim 9, where a first conductor is electrically coupled to the first electric coupler, and where a second conductor is electrically coupled to the second electric coupler.

11. The method of claim 10, where the first conductor is electrically coupled to the second conductor.

12. The method of claim 9, where the first electric coupler and the second electric coupler are part of an electric energy transmission cable, and further comprising:
transmitting identification data for the electric energy transmission cable to the electric vehicle.

13. The method of claim 9, where the electric power is direct current electric power.

14. The method of claim 9, where the electric power is alternating current electric power.

15. The method of claim 9, where the electric power is supplied via a single battery, where the single battery is a traction battery.

16. A method for supplying electric power from an electric vehicle, comprising:
coupling a first electric coupler and a second electric coupler to the electric vehicle;
coupling a third electric coupler to an electric load external from the electric vehicle; and
supplying electric power to the electric load via flowing electric current from a first power source through the first electric coupler and from a second power source through the second electric coupler to the third electric coupler, the first power source different from the second power source.

17. The method of claim 16, where the first power source and the second power source are alternating current power sources.

18. The method of claim 17, where the first power source is a leading power source and the second power source is a secondary power source, where voltage phase output of the second power source is synchronized with voltage phase output of the first power source.

19. The method of claim 17, where the first power source is a leading power source and the second power source is a secondary power source, where voltage output of the second power source is synchronized with voltage output of the first power source, and where the first power source and the second power source are direct current power sources.

20. The method of claim 16, further comprising adjusting a maximum electric current output of either the first power source or the second power source in response to a temperature of either the first power source or the second power source.
